(19) United States
(12) Patent Application Publication
(10) Pub. No.: US 2022/0334551 A1
(43) Pub. Date: Oct. 20, 2022

(54) METHOD FOR THE MAINTENANCE OR EXTENSION OF THE FUNCTIONAL RANGE OF A SELF-PROPELLED MACHINE, AND FUNCTIONAL MANAGEMENT SYSTEM OR MAINTENANCE MANAGEMENT SYSTEM

(71) Applicant: BOMAG GMBH, Boppard (DE)

(72) Inventors: Benjamin SOMMER, Boppard (DE); Dietmar METZ, Boppard (DE); Mathias SCHROEDER, Boppard (DE); Christian GEERS, Boppard (DE); Hermann MUELLER, Boppard (DE)

(21) Appl. No.: 17/659,339

(22) Filed: Apr. 15, 2022

(30) Foreign Application Priority Data
Apr. 16, 2021 (EP) 21168771.0

(51) Int. Cl. G05B 19/406

(52) U.S. Cl. CPC G05B 19/406; G05B 2219/32234

(57) ABSTRACT

A method for the maintenance or extension of the range of functions of a self-propelled machine, in particular a tandem roller, single-drum roller, rubber-wheeled roller, refuse compactor, road finisher, road milling machine, recycler or stabilizer, comprising the steps: generating a code which can be identified at a short distance by a control device of the machine either automatically by the control device after a maintenance interval has expired, or after a request by an operator for an extension of the range of functions, wherein the code contains information about at least one machine state that changes in the course of operation of the machine, identifying the code by a mobile terminal, transmitting the information contained in the code to a central server, transmitting a release code from the server to the mobile terminal, transmitting the release code to the control device of the machine, enabling the maintenance interval or the extension of the range of functions.

### FIELD

The invention relates to a method for the maintenance or extension of the range of functions of a self-propelled construction machine for ground treatment, in particular a tandem roller, a single-drum roller, a rubber-wheeled roller, a refuse compactor, a road finisher, a road milling machine, a recycler or a stabilizer. Furthermore, the invention relates to a function or maintenance management system for carrying out a corresponding method.

### BACKGROUND

Generic machines are self-propelled construction machines, in particular road construction machines, as well as compactors. Generic road construction machines are typically used for the compaction of soils or asphalt layers, as well as for the paving or removal of asphalt layers. Generic refuse compactors are used to compact landfills. All generic machines are available today in a variety of different configurations, both in terms of hardware and software. In this way, each user can select the suitable machine configuration from the additional options offered by the manufacturers. However, the optimum machine configuration for the user can change during the service life of generic machines, not least due to different requirements of a particular application, for example. For example, it regularly happens that additional hardware has to be retrofitted to the generic machines or, if necessary, removed again. Often, the corresponding hardware also has to be enabled or disabled again on the software side. In addition, users often require pure software retrofits, for example if an additional control algorithm for a working unit of the machine is necessary or desired, or if parameters of existing control algorithms are to be modified (for example, a new parameter set for engine control when used in warm areas, more efficient engine operation, etc.). For such retrofitting procedures, a cumbersome communication path with the machine manufacturer usually has to be taken. Details of the machine and the desired configuration change often have to be discussed by telephone with a service hotline of the machine manufacturer. Typically, long columns of numbers, such as the serial number of the machine or material numbers, have to be passed on verbally. This process is tedious, time-consuming, not process-safe and error-prone.

A similar situation exists when maintenance work has to be carried out on the generic machines. Typically, the maintenance intervals can be found in written documentation, such as a service manual. If necessary, additional help texts for the maintenance work are stored on the on-board computer, but these are not always up to date. In particular, the on-board computers present on generic machines, on which the machine's software runs, are typically not connected online to the Internet. Software updates can often only be performed by service technicians. It is therefore not possible for the manufacturer of the machine to always provide up-to-date information on maintenance for the operator on the on-board computer and/or to provide him with the optimum setting. Here, too, this often results in telephone queries, for example, which are again fraught with the problems already described and are tedious and time-consuming.

It is therefore the object of the present invention to provide an option of how an extension of the range of functions or maintenance can be made simpler, more economical and faster in a generic machine. One objective of the invention is to provide the operator of the generic machine with the highest possible degree of flexibility with respect to the hardware and/or software configuration of his or her machine. At the same time, it is to be ensured that no safety risk arises as a result of a configuration change on the machine. A further objective is to ensure process reliability and automated, machine-based and seamless documentation.

### SUMMARY

The object is achieved by means of a method and a function or maintenance management system according to the independent claims. Preferred further embodiments are specified in the dependent claims.

Specifically, the object is achieved by a method for the maintenance or extension of the range of functions of a self-propelled machine, in particular a road construction machine, in particular a tandem roller, single-drum roller, rubber-wheeled roller, refuse compactor, road finisher, road milling machine, recycler or stabilizer, comprising the steps:
generating a code which can be identified at a short distance by a control device of the machine either automatically by the control device after a maintenance interval has elapsed or after a request by an operator for an extension of the range of functions, wherein the code contains information about at least one machine state that changes in the course of operation of the machine,
identifying the code through a mobile device,
transmitting the information contained in the code to a central server, in particular by the mobile device,
transmitting a release code from the server to the mobile device,
transmitting the release code to the control device of the machine,
enabling the maintenance interval or the extension of the range of functions.

The short distance refers, for example, in particular to a distance of no more than 1 m, preferably no more than 50 cm, particularly preferably no more than 40 cm, no more than 30 cm, no more than 20 cm or no more than 10 cm. In particular, the machine should not have to be connected to a supra-regional communication network, for example the Internet or the telephone network. All that matters is data transmission between the machine or the control device of the machine and the mobile terminal.

Since a smartphone is the preferred mobile terminal, all wireless data connections that enable direct data transmission between the machine or the control device of the machine and a smartphone can also be used. As already indicated, it is preferred here that the data transmission takes place directly between the mobile terminal and the machine or the control device, without, for example, the Internet being interposed. The code that can be identified at a short distance can be implemented, for example, as a signal transmitted by a short radio link. Thus, in a preferred embodiment of the method, it is provided that the code which can be identified at a short distance comprises a signal for wireless transmission of data, in particular a Near Field Communication (NFC), Bluetooth, Wireless Local Area Network (WLAN), Radio Frequency Identification (RFID) or infrared signal. An advantage of this embodiment is that the release code, which is described in more detail below, can also be transmitted directly from the mobile terminal to the control device without the operator having to enter it manually at the control device. In this way, work is saved for the operator on the one hand, and on the other hand a source of error when entering the code is excluded.

A particularly preferred variant of the invention provides for the use of an optoelectronically readable code. In this way, the machine must only comprise a display device on which the code is displayed and a means for an operator to enter a release code on the control device. Thus, the machine need not include a means for wireless data transmission. Thus, this variation of the invention relates to a method for the maintenance or extension of the range of functions of a self-propelled machine, especially a road construction machine, in particular a tandem roller, single-drum roller, rubber-wheeled roller, refuse compactor, road finisher, road milling machine, recycler or stabilizer, comprising the steps of:
displaying an optoelectronically readable code on a display device of a control device of the machine either automatically by the control device after a maintenance interval has elapsed or after a request by an operator for an extension of the range of functions, wherein the code contains information about at least one machine state that changes in the course of operation of the machine,
reading the code through a mobile device,
transmitting the information contained in the code to a central server, in particular by the mobile device,
transmitting a release code from the server to the mobile device,
entering of the release code at the control device of the machine by the operator,
enabling the maintenance interval or the extension of the range of functions.

Generic machines are typically equipped with an on-board computer on which software is run to control the machine and interact with the operator. The control device according to the invention may be comprised by the on-board computer or may be the on-board computer itself. In this regard, the control device may comprise hardware and/or software necessary for performing the machine-side steps of the method according to the invention. The control device comprises a display device, for example a screen or display, in particular a touch screen. The display device may, for example, be one of the display devices of the on-board computer of the machine.

At the control device, supported for example by the display of information via the display device, an operator can select an extension of the range of functions and, for example, have information about it displayed. This can, for example, be specifically called up by the machine operator under a corresponding menu item or suggested by the machine or the on-board computer. An extension of the range of functions according to the invention can be any configuration change of the machine. Both changes to the hardware configuration and changes to the software configuration as well as both at the same time are possible. An extension of the range of functions thus refers, for example, to the addition or removal of a hardware component, for example an auxiliary device, and/or the activation or deactivation of a software component. For example, an extension of the range of functions may consist in enabling a software-based control option for the machine per se or a special working unit of the machine. In particular, the invention relates to software options that are already enabled by the software available on the machine but may not yet be enabled. For example, it may involve the activation of specific parameter sets from a number of parameter sets stored on the machine, such as different language packages. The extension of the range of functions according to the invention at the software level therefore does not require any updating or addition to the software of the machine per se, in the sense of additional or modified source code. Only functions already created and realizable in the software are activated or enabled. In a simple case, for example, it may be that an extension of the range of functions is to set an alternative display mode or preparation of information on the display device. In a further development, however, it is also possible to transmit an additional or modified source code, for example in the sense of a software update, via a data exchange from the mobile terminal to the control device. It is also possible to extend the range of functions by adding a hardware component to the machine and then enabling this hardware component on the software side so that the control device can recognize and control the new hardware component. According to the invention, an extension of the range of functions is also understood to be a dismantling of a hardware component and/or a software component, i.e. the reverse process. In this case, the extension lies in the fact that, by dispensing with unused components, simpler and more economical operation of the machine is ensured. In the following, this process is described using the example of an optical code as a transmission variant. As mentioned above, the transmission variant can alternatively be implemented as a short radio link. The features and further developments mentioned below therefore also apply in a figurative sense to the embodiments of the code which can be identified at a short distance, for example with a short radio link.

If the operator wishes to perform the selected extension of the range of functions and confirms this on the control device, the control device displays an opto-electronically readable code on the display device. This is in particular a barcode or a QR code. This machine-readable code contains the relevant data for the extension of the range of functions desired by the operator, as will be explained in more detail below. In addition, the code contains information about at least one machine state that changes in the course of operation of the machine. The display device is configured to display the code in such a way that it can be read by a mobile terminal, for example via a camera of the mobile terminal. The mobile terminal device is in turn preferably a smartphone or tablet, in particular in the possession of the operator of the machine. These typically have the necessary hardware to read optoelectronically readable codes, such as a digital camera device. In addition, machine operators typically have their smartphones with them all day long, so no additional effort is required by using them as mobile terminals. Software from the machine manufacturer is operated on the mobile terminal, for example a service app. When referring to functions of the mobile terminal, it is assumed that it contains software, for example the service app, which supports or performs the corresponding functions. With the mobile terminal, in particular using the service app installed on the mobile terminal, the code can be read and, if necessary, also processed. Beyond the purely optical display of the code on the display devices of the machine, there is therefore no data connection between the machine and the mobile terminal device. The information displayed by the control device or the machine via the code on the display device is recorded by the mobile terminal, for example via a camera device encompassed by the mobile terminal in a manner known per se, and processed further on the software side. For example, information about the operation associated with the code, such as the extension of the range of functions, can be displayed to the operator. Further information linked to the extension of the range of functions, such as required payment transactions, status displays, additional configuration requirements, service contact data, etc. can then be generated and displayed on the mobile terminal by the service app. Since the mobile terminal typically has an Internet connection, for example GSM, LTE, WLAN, etc., this information can be retrieved on a daily basis from a central server, for example of the machine manufacturer, and therefore always provide the operator with up-to-date information, even if this information is not available on the machine itself. In addition, for example, the language in which the information is displayed can be adapted, preferably automatically, to the current language setting of the mobile end device to ensure that the operator receives the information in a language he knows and is familiar with.

As mentioned above, the code contains information about at least one machine state that changes during the operation of the machine. Accordingly, this information changes dynamically in the course of operation of the machine. As a result, the information contained in the code also changes, which may vary depending on when the code was created. A machine state that changes in the course of operation of the machine is understood to mean all states whose current value can change in the course of time or in the course of operation of the machine. This includes, for example, information on the operating times of the machine, on the operating times of work equipment or on the operating times of wear parts that increase over time or during operation. Furthermore, this also includes information on maintenance intervals or the expiry of maintenance intervals or on configuration data of the machine. The configuration data of the machine can change, for example, as a result of an extension of the range of functions according to the present description, for example because the machine has more or fewer working devices or a different version of software after such a change. In other words, this refers to dynamic information about a machine state that is to be included in the code. In contrast, machine states that do not change in the course of operation of the machine are, for example, static identifiers of the machine such as a serial number or other identification. The machine state that changes in the course of operation of the machine can therefore refer in particular to all of the information mentioned below that changes in the course of operation and that can be included as information in the code or stored therein. In particular, it is envisaged that the control device monitors the machine states that change in the course of operation of the machine and provides information about their current state. In this way, the control device can take the information into account when generating the code.

According to the invention, the information contained in the code is transmitted to a central server, for example via the mobile terminal. The central server is operated by the machine manufacturer and comprises corresponding software via which the steps of the method attributed to the central server are carried out. In particular, both the mobile terminal or the software running on it and the central server or the software running on it are configured to communicate with each other, in particular to exchange data. The communication between the mobile terminal and the central server can be implemented using any mobile radio standards and can include any combination of direct communication, communication via cloud computing networks or communication via satellites and so on. Typically, communication is via the Internet using mobile Internet access available at the mobile terminal. The central server receives the information stored in the code from the mobile terminal and processes it vendor-side. This includes, for example, checking the transmitted information for plausibility and meaningfulness in order to avoid communication errors. In addition, it is checked whether the relevant extension of the range of functions is available for the machine concerned and whether the machine meets the requirements for the extension of the range of functions. This is explained in more detail below.

If all the prerequisites for the desired extension of the range of functions are met, for example if all the necessary hardware components are mounted on the machine and/or the corresponding software components are available, an enable code is created on the central server and transmitted to the mobile terminal. The release code can be a multi-digit number, for example a 6-digit number. This release code is displayed to the operator on the mobile terminal. The control device in turn provides the operator, in particular on the display device, with an input mask in which he or she can enter the release code and transmit it to the control device of the machine. The input can be made, for example, via the control device, for example a keyboard, or the display device, if this is configured as a touchscreen. Alternatively, the input can likewise be made, for example, via various keys on an operating device, for example a travel lever or joystick, of the machine. If the equipment of the machine itself has an optical recording device, for example a scanner or a video camera, it can also be provided that an optoelectronically readable code is generated and displayed on the mobile terminal on the basis of the data transmitted from the central server, which the operator then holds in front of the optical recording device of the machine for reading. After input/recording, the control device uses a suitable algorithm to check whether the release code actually originates from the machine manufacturer's central server and whether the release code is valid for the selected extension of the range of functions. If all these requirements are met, the control device on the machine enables the extension of the range of functions desired by the operator. This means, for example, that a desired software function is available and can be used immediately. A new hardware component can also be activated by the enabling process so that it can be used immediately. Without enabling with a release code, on the other hand, both the desired software functions and the operation of the desired hardware component are prevented. For security reasons, it may also be possible for the release code to be transmitted to the user by telephone or by other means, such as e-mail. This is intended in particular for emergencies in which a direct data connection of the central server with the mobile terminal fails.

An advantage of the present invention is that the control device of the machine does not require complex or expensive means of data communication. The control device only needs to be able to display the code on the display device and be able to accept a release code. In contrast, there is no need for the control device of the machine itself to communicate with the central server, for example, via mobile radio. It is therefore preferred that the machine or the control device communicate with the other elements covered by the method, in particular the mobile terminal and the central server, exclusively by reading out the optoelectronically readable code and entering the release code. The data transmission itself is handled by the mobile terminal, which is placed between the machine and the central server. This is achieved particularly easily in that the mobile terminal is preferably a smartphone carried by the operator of the machine anyway, and all that needs to be installed on it is appropriate software, for example the service app, to enable the smartphone to be used in the process according to the invention. Despite a lack of direct communication between the server and the machine, however, it is not necessary according to the invention to forward information about the machine indirectly to the manufacturer via the operator, for example by telephone. The information can be conveniently extracted from the machine-readable code via the mobile terminal and transmitted directly via the Internet. At the same time this ensures that the information displayed to the operator about the current operation does not have to originate from the machine or the machine's control device. The control device of the machine merely determines which operation is basically involved. The information about this operation is then obtained from the central server via the Internet, so that the operator has up-to-date information available without the need to update the software of the on-board computer or the control device of the machine, for example. At the same time, the method according to the invention ensures that configuration changes to the machine are also always supervised by the manufacturer, which ensures that no safety risks can arise. On the contrary, manufacturers are thus enabled to continue to rely on the highest quality of service and to guarantee this themselves. This can go so far, that digital documentation of maintenance and/or range of function changes is possible on the manufacturer side.

The code, which can be read optoelectronically in particular, can contain essentially all the information that is important for the machine manufacturer in order to assess whether the requirements on the machine are fulfilled in order to carry out or enable or activate the desired extension of the range of functions. Thus it can be preferably provided that the code contains at least one, preferably all, of the following information, whereby the following listing contains also information, which describes changing machine conditions in the course of the operation of the machine: The serial number or serial number of the machine, a current time at the location of the machine, for example in the form of a time stamp, in particular in coordinated universal time (UTC), the location of the machine, for example as GPS coordinates or within the framework of another, in particular global, positioning system, the operating time of the machine, the operating time of a working device of the machine, in particular a drive motor, a vibration drive, a milling drum, of a screed heating system and/or a paving screed, the operating time of a wearing part of the machine, in particular an air filter, an oil filter, a scraper, a belt, an ejector, a travel device and/or a wear pad, an identification of the code, the type of maintenance whose maintenance interval has expired, the desired extension of the range of functions, and/or the current machine configuration, in particular machine hardware and/or machine software. The identification of the code refers, for example, to the fact that the code contains information about the purpose for which it was generated, i.e., for example, due to an extension of the range of functions or an expired maintenance interval. This serves to ensure that both at the mobile terminal and at the central server, the software can immediately recognize which process is involved, so that the necessary and correct information can be displayed in each case and the appropriate procedural steps can be initiated. In addition to the purposes mentioned, other functions can be fulfilled by similar codes, for example the output of error information or the reading of work logs. The identification of the code ensures that the current operation is correctly assigned. The current machine configuration also includes, in particular, the version number of the software of the on-board computer or the control device. This is important so that it can be determined which software configurations are supported by this version and which are not. The use of a checksum in the code can ensure that errors in data transmission, in particular between the mobile terminal and the central server, can be detected. This prevents communication errors from disrupting the process.

Another piece of information that can preferably be contained in the code is a current oil quality, for example of a hydraulic oil or an engine oil. For example, the current viscosity of the oil can be used to determine its quality. Corresponding sensors are known in the prior art and are familiar to the skilled person. Preferably, therefore, a quality sensor is provided which determines the oil quality and transmits it to the control unit. In addition to or as an alternative to the oil quality, other parameters of the oil can also be used, for example the operating time of a working hydraulic system and/or a minimum temperature reached and/or a maximum temperature reached by the oil. The fact that the oil quality is also transmitted to the central server as information contained in the code means, for example, that a maintenance interval for the machine can be adjusted. If, for example, it is determined that the oil quality is already very poor, maintenance can be brought forward, i.e. a maintenance interval can be shortened. Conversely, maintenance can also be postponed, i.e. a maintenance interval can be extended, if it is determined that the oil quality is sufficiently high. In addition, it can be determined, for example, whether or not an oil change is necessary when maintenance is due. Thus, if maintenance is performed for reasons other than an oil change, it can be decided based on the current oil quality that an oil change is not currently necessary and can be postponed until the end of the next maintenance interval. This can also be conveyed by communication between the control device and the central server via the information in the code. Since the central server continuously contains information about the operation of the machine as well as the expiry of the maintenance intervals and the oil quality, this can also be used to adapt the length of the maintenance interval to the actual oil quality. For this purpose, the server can, for example, evaluate information from many different machines and, based on this swarm knowledge, determine and set the necessary or most economically and ecologically sensible length of a maintenance interval. This can also be done dynamically, so that the length of the maintenance intervals is continuously adjusted.

Still another piece of information that can preferably be included in the code is the status of a counter comprised by the control device that counts, for example, the number of machine starts. For example, the counter may be integrated in the software of the control device. Thus, the control device counts and stores, for example, how many times the machine has been started. This can refer, for example, to a start of the control device itself or also, for example, to a start of the drive motor of the machine. An actuation of the ignition of the machine is also a possibility. All this information could therefore be regarded as a machine start.

As already indicated, it is preferably provided that a check is made on the central server and/or on the mobile terminal as to whether the current machine configuration or the machine configuration documented on the central server, in particular machine hardware and/or machine software, permits the desired extension of the range of functions. As already mentioned, this can be done with regard to the machine software by means of the version number of the software of the on-board computer and/or the control device, which is transmitted to the mobile terminal and the central server via the code. The configuration of the machine hardware, in turn, results either from the factory configuration and a sequence of all subsequent configuration changes, for example in the context of successfully implemented extension of the range of functions. Supplementary or alternatively, it is also possible for the current configuration of the machine to be detectable or to be at least partially interrogated by the machine or the control device before the optoelectronically readable code is generated, for example by hardware components that are attached to or detached from the machine being detectable by the control device and/or the on-board computer and being checked for presence and/or functional integrity. For this purpose, for example, sensors can be used to detect a mounted hardware component, for example, on the basis of the mounting positions, for example, using the key-lock principle. In addition, hardware components could also be detected or recognized via identification devices, for example RFID chips. Another possibility is to detect cable bridges. For example, it can be determined when a signal is measured at a control input, which indicates whether, for example, a plug has been inserted or a valve or sensor has been connected. In this way, the hardware configuration of the machine can be detected automatically. Alternatively, however, it is also possible to have the operator enter configuration changes of the hardware components of the machine, for example, on the on-board computer and/or the control device. The machine configuration is then created at least in part on the basis of the components specified by the operator. Combinations of these alternative methods are also possible, so that individual hardware components are recognized automatically, while others are specified by the operator. The machine configuration specified in the optoelectronically readable code is then used to check whether or not the requirements for the desired extension of the range of functions are met. In particular, this check can already be carried out on the machine side by means of the control device. In particular, the further steps of the process are only executed if the prerequisites are fulfilled. If the prerequisites should not be fulfilled, the operator, in particular on the machine-side display device directly and/or by generating a corresponding optoelectronic code on the machine and reading it out by the mobile terminal on the mobile terminal, is displayed a corresponding information message which at the same time preferably contains information about which prerequisites are specifically not fulfilled and/or which steps are necessary for the operator to fulfill these prerequisites. This can, for example, be a specific instruction for action, for example with work steps that must be completed on the machine itself. On the other hand, however, this can also be, for example, contact data for a service partner of the machine manufacturer who can carry out the corresponding work in order to fulfill the requirements for the extension of the range of functions. The location of the machine can also be used to select a service partner that is as close as possible to the current location of the machine.

The method according to the invention is particularly well suited to tailoring the entire method for an extension of the range of functions individually to the circumstances at hand and the persons involved. It is helpful here if the mobile terminal can be assigned to a group of persons or, in the best case, to a single person. This is also the case, for example, if the operator of the machine uses his own smartphone as a mobile terminal. In this case, the operator can identify and/or authenticate himself to the software on the mobile terminal. In this way, it can then be determined, for example, to which extension of the range of functions or further functions of the mobile end device the operator is authorized to access. For example, it may be provided that a hierarchical structure with at least two service levels is stored on the central server and/or on the mobile terminal, with one service level being assigned to the user of the mobile terminal, and with the mobile terminal displaying different information to the user after reading the code, depending on his service level. Of course, more than two service levels can be used, for example 3, 4, 5, 6, 7, 8, 9, 10 or even more different service levels to which the users can be assigned. For example, 5 service levels are preferred. For example, it is possible to distinguish between pure machine operators and trained service technicians. In principle, all of the aforementioned persons can read the optoelectronically readable code with their mobile terminal. However, depending on the service level of the respective person, a different information content can be displayed. For example, a service technician whose service level is sufficiently high can be provided with information and instructions on how to carry out the extension of the range of functions. These can, for example, be concrete assembly instructions for work on the machine itself. A pure machine operator, for example, who does not have the corresponding service level, can be shown information on how to reach a service technician with a sufficiently high service level.

The use of such hierarchical service level structures can also be used to increase security. For example, the more extensive service levels with regard to the permitted information can be regarded as different authorizations that are granted only to trained personnel who can be expected to perform the necessary work in compliance with all security precautions. To ensure that security-relevant work is performed only by personnel authorized to do so, it is preferred that a check of the service level of the user of the mobile terminal is performed on the central server or on the mobile terminal and that the further steps, in particular the transmission of the release code from the server to the mobile terminal, are performed only if the user's service level is sufficient. The fact that the release code is only sent to the mobile terminal if the service level of the operator is sufficient prevents an operator who is not authorized to do so from simply starting up a function or configuration of the machine. This improves the operational safety of the machine. In addition or alternatively, the service level of the operator can also be included in the creation of the release code, so that the control device of the machine can read from the release code which service level the operator entering the code has. In other words, the service level of the operator is included in the release code. This also serves to provide additional security, since in this way the last instance, specifically the control device, can also check again whether the required service level is actually available for the desired extension of the function range or for the maintenance interval being processed. If the operator's service level from the release code does not correspond to the required service level for the currently targeted operation, the control device can refuse to accept the release code. In this case, the preferred information displayed to the operator is that which is provided if the service level is insufficient. This can be done directly on the control device or by the control device creating a new code that can be read by the operator with the mobile terminal.

In principle, the service level of the operator can also be a dynamic value. For example, an operator's service level can be increased, i.e., he or she can be assigned to a different service level, if, for example, he or she successfully completes a training course. Downgrading a service level is also possible. For example, an operator may attend regularly scheduled training sessions to maintain his service level. This may be necessary because various details may change or expand on a rotational basis, so it is necessary to ensure that the operator with an appropriate service level is actually up to date. If an operator misses appropriate training, their service level may be downgraded. Finally, it is also possible, either additionally or alternatively, for a service level to be temporarily upgraded. This is particularly helpful in an emergency. For example, if it is only possible to perform maintenance with a higher service level than an operator has on site, this operator can be guided through the maintenance remotely by personal instruction, for example by telephone or other means. In this case, the operator's service level can be temporarily upgraded so that he can also successfully complete the maintenance by entering the release code at the control device.

The method according to the invention is suitable for the operator of the machine to be able to put together his desired machine configuration from all possible options at any time. This means that the operator does not have to notify the machine manufacturer of a desired extension to the range of functions by any means other than the method according to the invention or, for example, make inquiries by telephone. The operator merely selects the extension of the range of functions he wants, for example via the control device or the on-board computer. Via the code, he reads out the information on the desired extension of the range of functions from the machine to the mobile terminal. It is then preferred that an order for an extension of the range of functions, specifically the one selected by the operator, is created on the mobile terminal and transmitted to the central server. If the extension of the range of functions is one that requires payment, it may also preferably be provided that the central server transmits a payment request to the mobile terminal. Within the scope of the method according to the invention, it is therefore possible to provide for both order creation and payment processing for extension of the range of functions requiring payment. For example, the payment can be made directly from the mobile terminal using online payment services. The central server and the software of the mobile terminal therefore together form an online store for the extension of the range of functions. It is particularly preferred that a check of a receipt of payment is carried out at the central server or at the mobile terminal and that the further steps, in particular the transmission of the release code from the server to the mobile terminal, are only carried out if a receipt of payment has been detected. This ensures that only paid functional extensions can actually be put into operation. Alternatively, a classic invoicing process can also be triggered.

The release code can be an at least partially randomly generated numerical code. The release code is generated on the central server or on the mobile terminal. The generation of the release code is based on an algorithm that ensures that the control device of the machine can understand from the release code that it actually originates from the central server and is intended for the current release process. In particular, therefore, various information, such as the serial number of the machine and/or the time of creation of the release code and/or the type of current operation, is taken into account in the creation of the release code in such a way that it can be traced by the control device on the basis of the release code. For example, it is preferred that the release code is created in such a way that it is only valid for the machine in question and/or only for a limited period of time. In this way, it can be ensured that the same release code is not used to release different extension of the range of functions or the same extension of the range of functions on different machines. By restricting the validity to a limited period of time, further misuse is avoided.

As described above, the new function or the new hardware can be put into operation by enabling the extension of the range of functions. As already described, the process according to the invention is also suitable for selling machine options. Newly purchased options are activated and made permanently available to the operator. The activation of the extension of the range of functions is valid for an unlimited period of time. However, the process according to the invention can also be used not only to sell functional extensions of the machine, but also to rent them out if necessary. For this purpose, it can be provided that the activation of the extension of the range of functions is valid for a limited period of time. The time period for which the activation is to apply can be selected by the operator, for example at the control unit, and in particular is also included in the information in the optoelectronically readable code. In this way, a time limit can be taken into account in the subsequent process steps, for example during order creation and billing. In addition or alternatively, the release code can also be valid for an unlimited or limited period of time. A release code that has expired in time is not accepted by the control device. A time-limited release code ensures that it is actually only used for the process for which it was intended, thereby increasing the security of the process.

The method according to the invention may comprise a number of checks. For example, the communication between the mobile terminal and the server can be checked. In addition, it can be checked whether the machine fulfills the requirements for a desired radio range extension, etc. In each of these checks, a negative result may be obtained. However, the objective of the method is to support the operator in providing him or her with the desired extension of the range of functions. To ensure that a negative result of one of the plurality of checks or verifications does not lead to an abort of the method without comment, it is preferably provided that an information output is displayed to the operator on the mobile terminal in the event of a negative result of a check, in particular with instructions for troubleshooting and/or a contact to a service partner. Even in the case of a negative result of a check, a way out or a solution for the underlying problem should therefore be shown in a constructive manner In the worst case, this solution lies in the indication that a service partner must be contacted. As already explained, this is preferably a service partner located in the vicinity of the machine. Even then, however, this will show the operator a way to get the desired extension to the range of functions.

The operator should be enabled to obtain easier access to all optional function range extensions available for his machine via the method according to the invention. For this purpose, it can be provided, for example, that a list of several or all possible extension of the range of functions is stored in the control device and the operator selects a desired extension of the range of functions from this list. The method according to the invention is then carried out with reference to this selected extension of the range of functions. In addition or alternatively, it is also possible for the control device to make suggestions to the operator during operation of the machine regarding available extension of the range of functions of currently used functions and/or currently enabled extension of the range of functions of the machine, which can be selected by the operator. The operator thus operates the machine in the usual way. While he is operating certain functions or working devices of the machine, an indication can be displayed on the control device that options or extension of the range of functions are available for the current function or the current working device. In addition, if the operator enables an extension of the range of functions, for example via the method according to the invention, further available extension of the range of functions can be displayed to the operator. These are, in particular, extension of the range of functions that could be of interest to the user. For this purpose, the data of other machines or other users are used on the central server, for example. For example, extension of the range of functions are displayed that have also been enabled by other users with similarly configured machines. In addition or as an alternative, extension of the range of functions can also be suggested that match the currently enabled extension of the range of functions. For example, if the customer has just enabled an edge trimming wheel, the control unit can display a suggestion about variants of further edge trimming wheels. The available extension of the range of functions can also be displayed directly. If the operator selects one of these extension of the range of functions, the process according to the invention is carried out with reference to this selected extension of the range of functions.

As explained above, an extension of the range of functions according to the invention may comprise a software-only modification, a hardware-only modification, or a hardware modification in combination with a software modification. In particular, the extension of the range of functions may involve at least one of the following functions: Edge cutter right and/or left (for attachment to rollers, used to produce clean edges on asphalt layers), faster or slower crab steering (relates to a travel mode of tandem rollers and can be achieved via a software change alone), grit spreader, gyratory grit spreader (for attachment to rollers), interface measuring technology (via the interface, various measuring devices, each with its own intended use, can be connected to the control device), Obstacle detection (in conjunction with cameras or other sensors, for example), immobilizer (can be accessed via a PIN entry on the on-board computer, for example, and in this case is a pure software change), radio remote control (requires software and hardware), telematics (depending on the application, a pure software change or connected to hardware), electric seat adjustment (requires software and hardware), key assignment of control lever (pure software change), freewheel activate flow divider, activate flow divider automatic (flow dividers increase the traction of hydraulic travel devices; may be a software-only change or require additional hardware), travel lever ramp setting (software-only change that triggers a sequence of different control commands in special work situations), inching mode (one button press triggers several travel commands in succession; may be a software-only change or require additional hardware), rotating beacon (for mounting on all machines), Coming/Leaving Home (various functions are activated automatically at the start or end of operation; may be a software-only change or require additional hardware), Tire Pressure Monitoring System (requires software and hardware), ECO Stop (software-only change that turns off the engine to save fuel after a certain amount of time at idle), Compression Monitoring (may be a software-only change or require additional hardware, for example, sensors), compression control display modes (software change only), electric mirror adjustment (requires software and hardware), rearview camera (requires software and hardware), Bird view (display mode that creates a bird's-eye view of the machine from multiple camera images around the machine; requires software and hardware), drone camera (requires software and hardware), virtual/augmented reality (requires software and hardware), asphalt temperature sensor (requires software and hardware), split scraper blade (requires software and hardware), AdBlue filling pump (requires software and hardware), dust extraction (requires software and hardware), side plate camera (requires software and hardware), activation of the milling drum during reverse travel (software change only), compressed air system (requires software and hardware), machine autonomy or partial autonomy such as automatic control, automatic following, automatic edge pressing, automatic leveling (requires software and hardware).

In the course of the method, a whole range of machine-specific information is transmitted to the central server, in particular all the information mentioned herein. This is documented and/or analyzed by the central server. The collected data is used for fleet, utilization and quality evaluation. In order to improve the service quality of the machine manufacturer vis-à-vis the operator, this information can be used to tailor the manufacturer's service individually to the machine or its current configuration. It is therefore preferred that a machine history is created and stored at the central server from the transmitted information contained in the code, and in particular also the enabled maintenance intervals and/or extension of the range of functions. In this way, a digital service booklet or checkbook is created for the machine, showing the current configuration of the machine and its past configuration changes. This can be used, for example, to ensure that a service partner always has the appropriate spare parts and tools for maintenance and service work on the machine when visiting a construction site.

In addition to the activation of extension of the range of functions, the method according to the invention also relates to the activation of maintenance intervals. The method according to the invention with regard to the expiry of maintenance intervals and their activation or acknowledgement is to be seen as a supplement to or an alternative to the method with regard to the activation of extension of the range of functions and can also be claimed independently of the latter. At the same time, the process steps, features, advantages and effects of the process relating to the extension of the range of functions also apply in a figurative sense to the process relating to the maintenance intervals and vice versa.

As already explained, the display of an optoelectronically readable code on the display device of the control device can also be carried out automatically by the control device after the expiration of a maintenance interval. For example, an indication is then displayed that the corresponding maintenance interval has expired and what maintenance is required. Here, too, the code is read out with the mobile terminal and, in particular depending on the service level of the operator, information on maintenance is provided. As described above, this information can include, for example, an instruction for the maintenance itself if the operator's service level is sufficiently high, or information about a service partner who can perform the maintenance. Either the operator or a service partner then performs the maintenance. The release of the maintenance interval that occurs at the end of the method according to the invention means that the expired maintenance interval is acknowledged. The operator who has requested the release code for the maintenance interval and received it at the control device stands with his name for the fact that the maintenance has been carried out completely and correctly.

Supplementary or alternatively, it can be provided that the actual performance of the maintenance is monitored more closely. This is possible, for example, if sensors are available on the machine that are capable of tracking the maintenance. For example, wear parts that need to be replaced may be equipped with an identification device, such as an RFID chip, so that the control device can track the replacement of the wear parts. In this case, the optoelectronically readable code also includes information about whether or not maintenance has already been performed. These are then also transmitted to the central server. Preferably, it is envisaged that maintenance work must be carried out on the machine before the release code is transmitted. In order to make this traceable, it can be provided that an optoelectronically readable code is generated by the control device both before and after the maintenance has been carried out, whereby the code after the maintenance contains the information that the maintenance has been carried out successfully. After the information contained in this code has been transmitted to the central server, the latter proceeds with the further steps of the method, in particular with the generation and transmission of the release code to the mobile terminal. In this way, it can be ensured that maintenance is performed correctly and only by adequately trained personnel.

The invention also extends to a function or maintenance management system designed to carry out the methods described above. For this purpose, the function or maintenance management system comprises a self-propelled machine, in particular a road construction machine, in particular a tandem roller, single-drum roller, rubber-wheeled roller, refuse compactor, road finisher, road milling machine, recycler or stabilizer, with a control device and a display device, a mobile terminal, in particular comprising a device for detecting an optoelectronically readable code displayed on the display device, and a central server. All the features, advantages and effects described above for the methods according to the invention apply in a figurative sense likewise to the function or maintenance management system according to the invention.

### BRIEF DESCRIPTION OF THE DRAWINGS

The invention is explained in more detail below with reference to the embodiments shown in the figures. They show schematically:

FIG. 1: a tandem roller;

FIG. 2: a single-drum roller;

FIG. 3: a rubber-wheeled roller;

FIG. 4: a refuse compactor;

FIG. 5: a road finisher;

FIG. 6: a road milling machine;

FIG. 7: a functional or maintenance management system;

FIG. 8: a control device with a display device;

FIG. 9: a control device with a display device and the functional relationship with a mobile terminal and a central server;

FIG. 10: a flowchart of the method for extending the range of functions;

FIG. 11: a flowchart of the maintenance method; and

FIG. 12: a flowchart of an alternative maintenance method.

### DETAILED DESCRIPTION

Components that are identical or have the same effect are identified by the same reference signs. Repeating components are not designated separately in each figure.

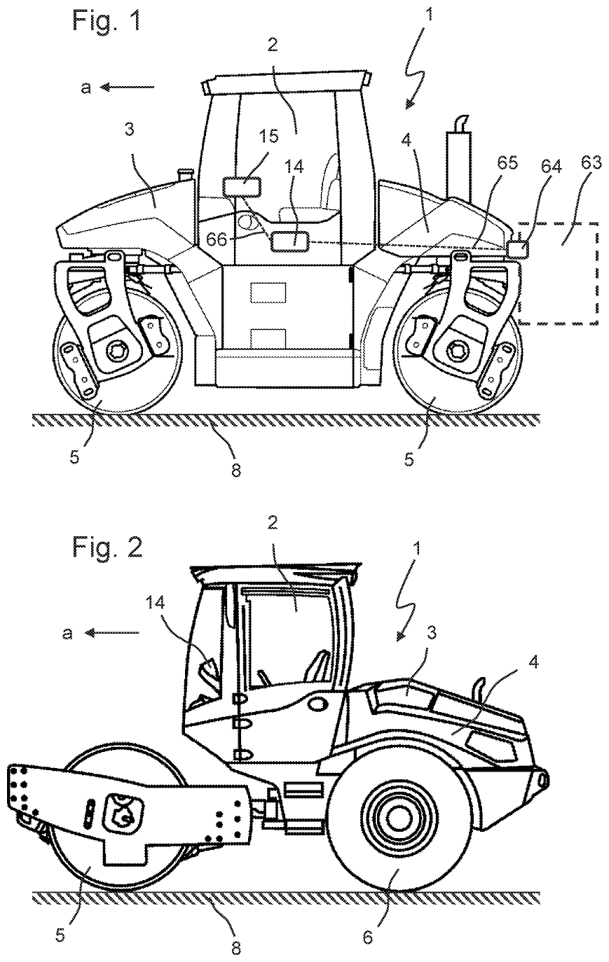

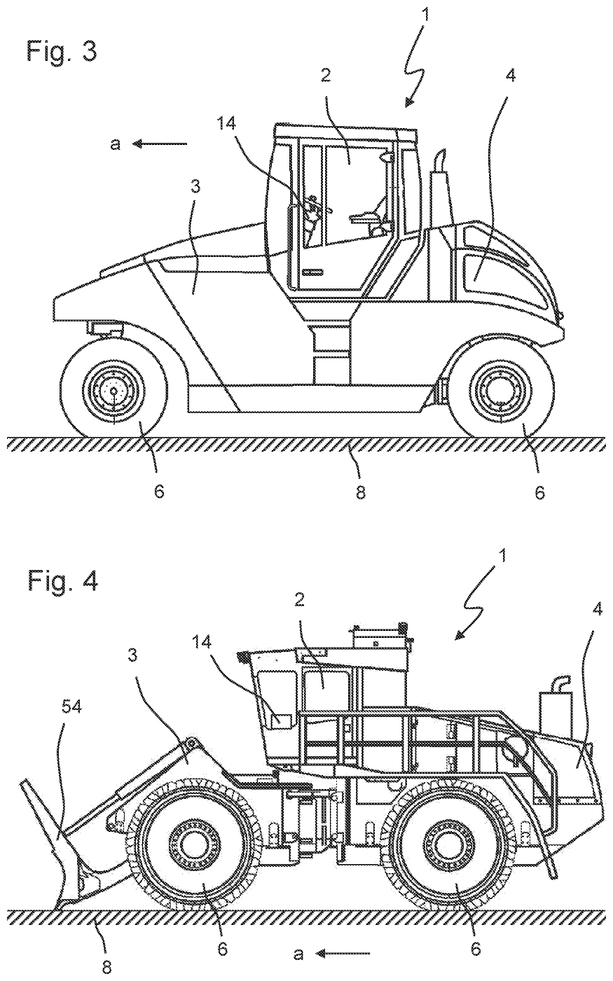

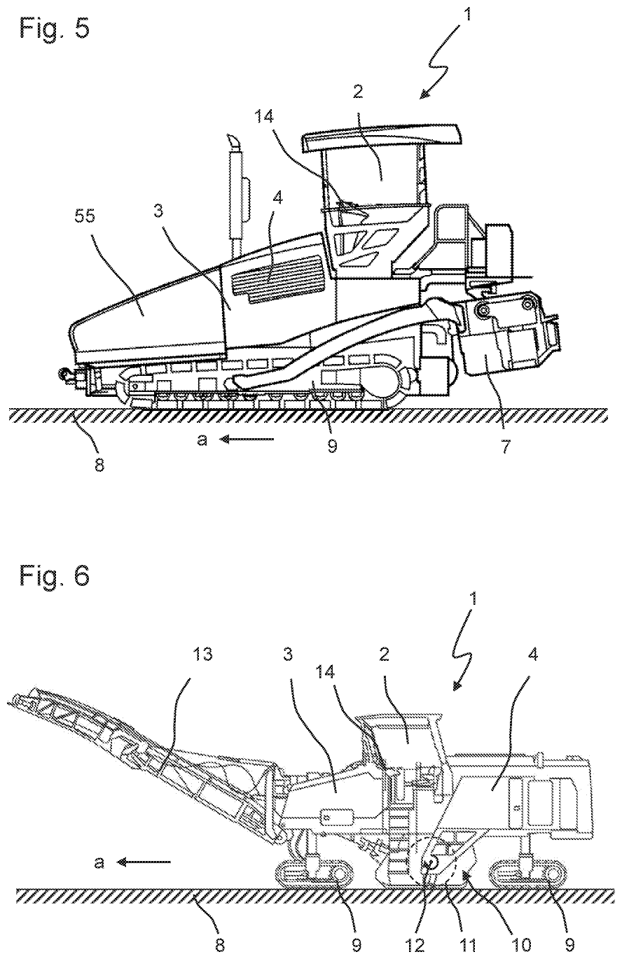

FIGS. 1-6 show generic machines 1. All generic machines 1 are self-propelled and comprise a machine frame 3, an operator's cab 2 and a drive engine 4, typically a diesel combustion engine or an electric motor. In working mode, they typically move in working direction a on a ground 8. For this purpose, they have different travel devices related to the respective function or field of application. FIG. 1 shows, for example, a tandem roller that has a roller drum 5 both at the front and at the rear, with which it compacts the ground 8. In the roller drums 5, a vibration exciter can also be provided, for example, by means of which the roller drum 5 can be made to vibrate in order to increase the compaction performance of the machine 1. FIG. 2 shows a single-drum roller that also comprises a roller drum 5 at the front in working direction a. The rear of the single-drum roller, on the other hand, comprises a roller drum 5. At the rear, however, the single-drum roller comprises wheels 6. The rubber-wheeled roller shown in FIG. 3 comprises rubber wheels 6 both at the front and at the rear. FIG. 4 again shows a refuse compactor. This comprises a compactor blade 54 at its front end in working direction a, with which refuse can be distributed to landfills. FIG. 5 shows a road finisher for paving asphalt layers. For this purpose, it comprises a material hopper 55 and a paving screed 7. The road finisher shown includes crawler tracks 9, but could also have wheels 6. Finally, a road milling machine is shown in FIG. 6, which also includes other ground milling machines such as recyclers and stabilizers. The road milling machine comprises a milling drum 11 rotatably mounted in a milling drum box 10 about an axis of rotation 12, which is used to mill off damaged roads, for example. The milled material removed is transferred to a transport vehicle via a conveyor 13 and transported away. These machine types are familiar to those skilled in the art, so their design and function will not be discussed in detail.

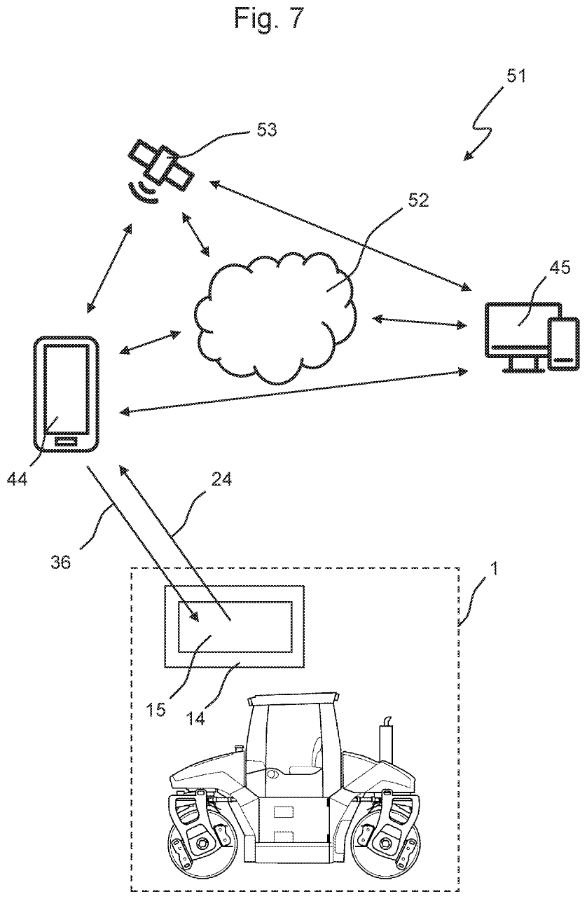

All machines 1 comprise a control device 14 with a display device 15 (see FIGS. 7-9). The control device 14 is, for example, part of the on-board computer of the machines 1. FIG. 7 shows an overview of a function or maintenance management system 51 configured to carry out the method. The system 51 comprises a machine 1, a mobile terminal 44 and a central server 45. The mobile terminal 44 is, at least temporarily, in contact with the central server 45 and can exchange data with it, for example via the Internet, a cloud 52, a satellite 53 or any other variants of, preferably wireless, remote data transmission. The mobile terminal 44 is configured, for example, as a smartphone or tablet and comprises a camera with which optoelectronically readable codes can be read from the display device 15 of the machine 1. While the mobile terminal 44 and, for example, the cloud 52, the satellite 53 and the server 45 are in constant data exchange, for example via an Internet connection, the transmission of data between the machine 1 and the mobile terminal 44 involves only a reading 24 of an optoelectronically readable code displayed on the display device 15 and an input 36 by an operator of a release code displayed on the mobile terminal 44. Any further data transmission between the machine 1 and the mobile terminal 44 is not provided, not necessary and does not take place in this embodiment example.

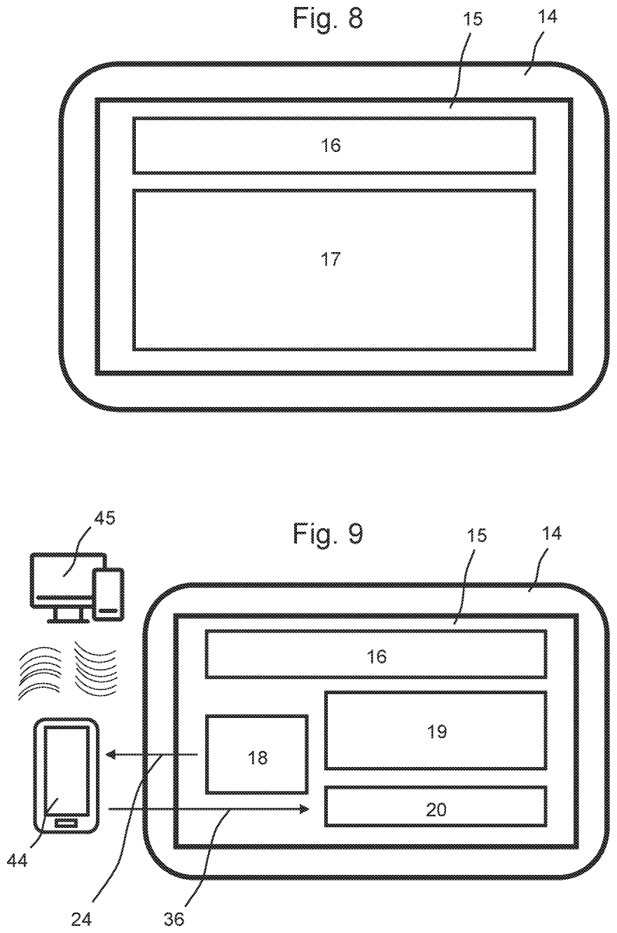

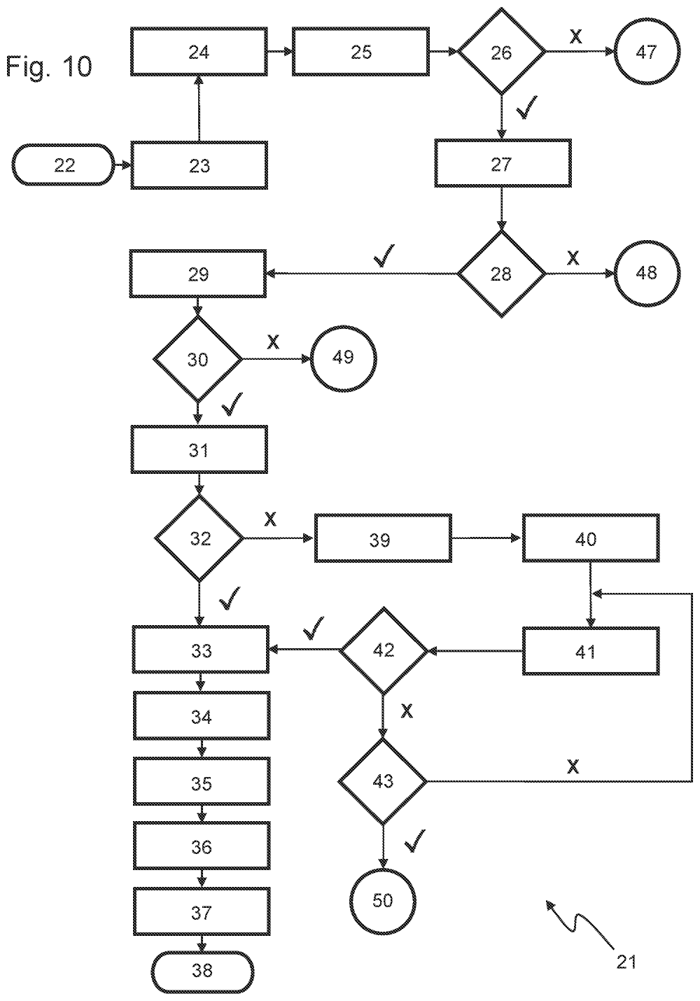

FIGS. 8 and 9 show a control device 14 with display device 15 and illustrate how, in one embodiment, an operator can start the process according to the invention. For example, according to FIG. 8, the operator is shown a menu heading 16 on the display device 15, for example “Available options/configurations”. In addition, the operator is shown a selection menu 17 that displays a list of all possible configurations or configuration changes, i.e., extension of the range of functions, which are available for the specific machine 1. In this list, for example, options are also available to undo an extension of the range of functions carried out in the past. Using control elements of the control unit 14 or, if the display device 15 is configured as a touch screen, directly via the display device 15 itself, the operator can now scroll through the list of available extensions of the range of functions and select one. As soon as a function range extension has been selected, the display on the display device 15 changes, for example, as shown in FIG. 9. Now the operator is shown an information output 19 under the menu heading 16, which in particular contains the designation of the selected extension of the range of functions, with various general information on the selected extension of the range of functions being compiled here. For example, information relating to the prerequisites for carrying out the extension of the range of functions which can be detected by the machine 1 may also be displayed here. For example, whether or not a necessary hardware element is already mounted on the machine 1 is displayed here, as long as this is detectable by the machine 1. Furthermore, the display device 15 shows the operator an optoelectronically readable code 18, which the operator can read (arrow 24) with the aid of the mobile terminal 44 and which contains the information already described above. Finally, the display device 15 also shows an input field 20, via which the operator can enter (arrow 36) the release code generated in the further course of the method at the control device 14. In this exemplary embodiment, there is no communication between the control device 14 and the mobile terminal 44, and in particular also the central server 45, beyond reading 24 the code 18 and entering 36 the release code. Further information transmission and processing is performed exclusively by the mobile terminal 44 and/or the central server 45. All the process steps explained in more detail below, from displaying the code 18 on the display device 15 to entering 36 the release code in the input field 20, are therefore carried out outside the control device 14 by the mobile terminal 44 and/or the central server 45, possibly with the assistance of the operator.

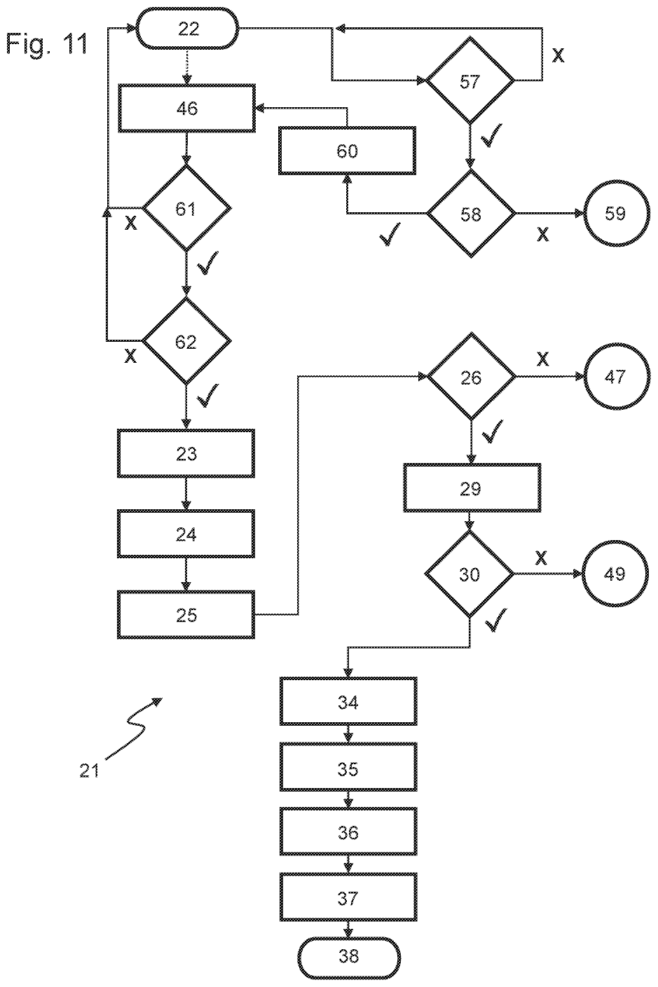

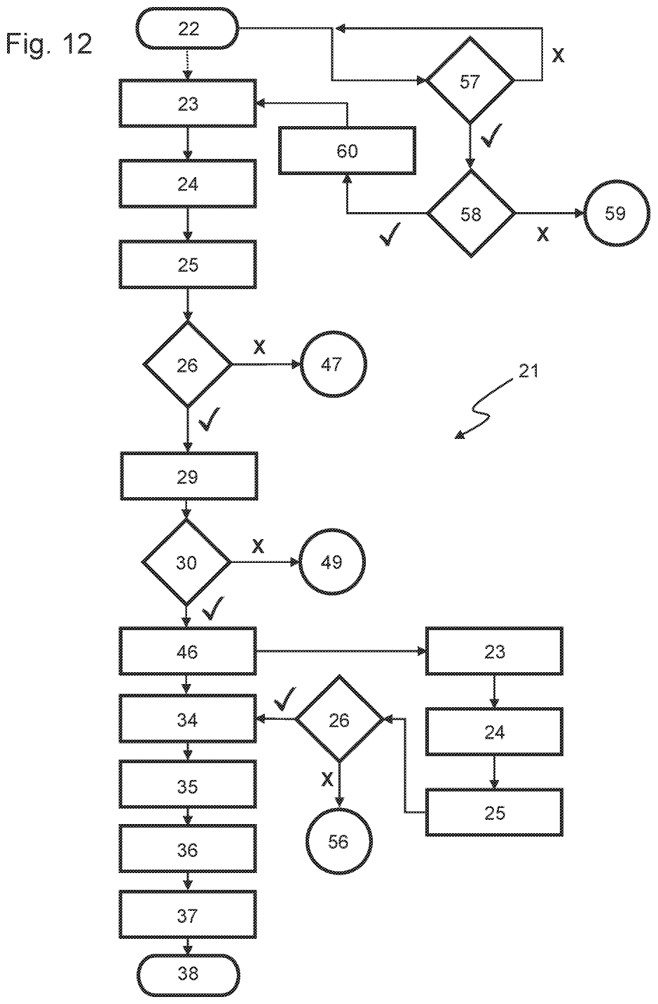

FIG. 10 shows a flow chart of the process 21 for extending the range of functions of the machine 1. In the flow chart according to FIG. 10 and also in the flow charts according to FIGS. 11 and 12, flow paths that are followed after a positive result of a check are indicated by a check mark. In contrast, flow paths that are initiated after a negative result of a check are indicated by a cross. The start of the process 21 is indicated by step 22. Here, for example, as described above, an extension of the range of functions is selected by the operator at the control device 14, either from a corresponding list or according to a suggestion made by the control device 14 during operation of the machine 1. Once the operator has selected a desired extension of the range of functions, an optoelectronically readable code 18 is displayed 23 on the display device 15. With the aid of the mobile terminal 44, the code 18 is then read 24, during which the information stored in the code 18 is received by the mobile terminal 44. The mobile terminal 44 then already displays to the operator information about the current operation, for example, about the further process for carrying out the extension of the range of functions. This information may be compiled differently, for example, depending on the service level of the operator of the mobile terminal 44. Importantly, even if the service level of the operator is not sufficient to perform the further steps himself, he is still offered constructive guidance on how to obtain the desired extension of the range of functions. This is ensured by displaying contact data for a service partner in the operator's vicinity. This is followed by the transmission 25 of the information stored in the code 18 from the mobile terminal 44 to the central server 45, for example via the Internet. At the central server 45, the information is processed and it is ensured, for example also on the basis of the checksum contained in the code 18, that the data transmission from the mobile terminal 44 to the server 45 has functioned sufficiently error-free. In addition, a check 26 of the code 18 is carried out to determine whether the transmitted code 18 belongs to the present method 21 at all. For this purpose, for example, the identification of the code 18 is examined to determine the purpose for which the code 18 was transmitted to the server 45. If the purpose lies in an extension of the range of functions, the method 21 proceeds as described herein. If, on the other hand, the purpose is, for example, an error message or other operation for which codes 18 generated by the control device 14 are transmitted to the server 45, then a transition 47 is made to the corresponding other subroutine of another procedure performed at the server 45, for example, for error reporting.

If checking 26 of code 18 shows that a function range extension has been requested by the operator, the next step is to check 27 to determine which specific extension of the range of functions is involved and which requirements must be met for this on machine 1. For example, it is possible to determine whether the desired extension of the functional range, or range of functions, can be achieved by modifying the software of machine 1 alone, or whether hardware modifications are also necessary. Once the requirements have been determined, a check 28 is performed to determine whether or not the machine 1 meets the software and/or hardware requirements for the desired extension of the range of functions on the basis of the information contained in the code 18. If it is determined that the machine 1 does not meet the necessary requirements, the server 45 transmits a corresponding message to the mobile terminal 44, at which an information output 48 takes place informing the operator which requirements for the desired extension of the range of functions are not currently met by the machine 1 and how he can meet these requirements. If the operator cannot fulfill these requirements himself, a contact to a service partner in his vicinity is suggested. If the check 28 shows that the machine 1 meets the prerequisites for the desired extension of the range of functions, the server 45 performs a check 29 of the necessary service level required to activate the extension of the range of functions on the machine 1 next. For example, extension of the range of functions that intervene in safety-relevant areas of the machine or whose activation may be safety-relevant on the machine 1 can only be performed by operators with a sufficient service level. These operators have then received appropriate training, for example, which enables and authorizes them to perform the necessary work. Once the necessary service level of the operator has been determined, a verification 30 is performed to determine whether the service level of the operator of the mobile terminal 44 is sufficiently high. For this purpose, the service level of the operator of the mobile terminal 44 may also be transmitted to the server 45 together with the information of the code 18. Alternatively, it is also possible for the mobile terminal 44 to transmit the identity of the operator to the server 45, for example via an individual code that complies with data protection requirements, and for the service levels of all possible operators to be stored on the central server 45. If the verification 30 reveals that the service level of the operator of the mobile terminal 44 is not sufficient to complete the extension of the range of functions on machine 1, the server 45 transmits this information to the mobile terminal 44, at which an information output 49 takes place informing the operator that his service level is not sufficient to fully enable the extension of the range of functions. Again, the operator is advised to contact a service partner with a sufficient service level.

If the service level of the operator of the mobile terminal 44 is sufficient, the next step is to check 31 whether the desired extension of the range of functions is subject to a charge or not. This is followed by a check 32 to determine whether payment has already been made or not. In the case of an extension of the range of functions that are not subject to a charge, payment is automatically and always considered to have already been made. If the server 45 detects a receipt of payment or an invoicing process, or if the feature enhancement is not subject to a charge, the next step is to specify 33 a time limit for which the feature enhancement is to be activated. The time limit can be infinite, for example, so that there is a permanent extension of the range of functions. This is the case, for example, if the operator buys the function range extension and it is then to be permanently usable on machine 1. Alternatively, the operator may only rent the desired extension of the range of functions for a certain period of time. Different time limits can also be selected at the control unit 14, for example, and are treated in the end like different function range extensions in process 21. Once the temporal limitation has been set 33, this is followed by a creation 34 of a release code by the server 45, in which, for example, both the temporal limitation and the machine 1 and any limited temporal validity of the release code are taken into account. Corresponding algorithms for generating the release code are known to the person skilled in the art and need not be explained in detail here. If the corresponding release code is available at the server 45, the release code is transmitted 35 to the mobile terminal 44, which displays the release code to the operator. The operator then enters 36 the release code at the control device 14, for example in the input field 20 on the display device 15. The control device 14 then checks the release code to ensure that the release code is actually intended for the machine 1 and, in particular, is still valid at the current time. If the control device 14 does not detect any irregularities, the next step is to enable 37 the desired extension of the range of functions, if necessary for the period of a time limit or permanently. The method 21 is then completed and ends in step 38. The function range extension is now available to the operator of the machine 1 and can be used immediately in operation.

If, when verifying or checking 32 the payment of an extension of the range of functions that is liable to cost, it is determined that a payment has not yet taken place, the corresponding transaction up to this point is counted as an order of the operator who wants to purchase the extension of the range of functions. In this case, the server 45 is used like an online store. Therefore, a creation 39 of an order for the provision of the extension of the range of functions takes place. Since the operator must pay for the chargeable feature enhancement, the next step is to transmit 40 a payment request from the server 45 to the mobile terminal 44. This is displayed to the operator accordingly, so that the operator can process the payment via online payment services, for example. Meanwhile, the server 45 waits 41 for the payment to be received. A check 42 is performed at regular intervals to determine whether the payment has been received. If the verification 42 reveals that the operator has paid for the desired feature enhancement and the payment has been received, the method 21 continues as explained above with the setting 33 of a time limit. In the event that the verification 42 indicates that no payment has been received, an additional verification 43 is performed to determine whether a timeout for the payment has occurred. If there is not yet a timeout, the wait 41 for payment is maintained. If, on the other hand, a maximum time available for making the payment has expired, a corresponding message is generated and transmitted to the mobile terminal 44. A corresponding information output 50 is then provided to the operator at the mobile terminal 44 that the payment has not been made due to a timeout, allowing the operator to correct the problem if necessary. For example, the operator may restart the process 21 and try again.

FIG. 11 shows a flow chart of the method 21 for maintenance of a self-propelled machine 1. The method 21 starts in step 22. The control device 40 checks at regular intervals whether or when a maintenance interval expires. For this purpose, a verification 57 is made whether the operating time of the machine 1 exceeds the maintenance interval minus a warning buffer. A constant, predefined time is deducted from the maintenance interval as a warning buffer. If verification 57 shows that the operating time of machine 1 does not exceed the maintenance interval minus the warning buffer, method 21 is reset. This means that method 21 starts again from the beginning. Otherwise, the next step is to check 58 whether the operating time of machine 1 exceeds the maintenance interval. Thus, during checking 58, no warning buffer is deducted any more. If checking 58 shows that the operating time of machine 1 does not exceed the maintenance interval, the operating time of machine 1 is in the warning buffer. Therefore, an information 59 is displayed to the operator, informing him that a maintenance interval is about to expire or that maintenance is necessary. The remaining duration of the warning buffer can also be displayed to the operator. If checking 58 shows that the operating time of machine 1 exceeds the maintenance interval, maintenance is due. The operator is therefore prompted 60 to initiate maintenance. For this purpose, a corresponding display is generated at the display device 15, which informs the operator of the need for maintenance. In addition, the operator is free at any time to actively initiate maintenance on his own initiative, as shown by the dashed arrow between steps 22 and 23 in FIG. 11.

In principle, the next step is to carry out the maintenance itself. This can be done by the operator or a service partner. A dialog box on the display device 15 at the control device 14 prompts 61 whether performance 46 maintenance has been successfully completed. If this is negated by the operator or the service partner, the method 21 is reset. If, on the other hand, the performance 46 of the maintenance is confirmed, the dialog box on the display device 15 next prompts 62 whether the operator or the service partner would like to reset the maintenance interval. If this is answered in the negative, the method 21 is also reset and is restarted with the maintenance interval still open. If, on the other hand, the operator or service partner confirms that the maintenance interval is to be reset, an optoelectronically readable code 18 is displayed 23 on the display device 15. The information contained in the code 18 can then be transmitted to the mobile terminal 44 by reading 24 the code 18. Information about the current operation can then be displayed to the operator by the mobile terminal 44, for example about the further progress until the service interval is acknowledged. This information may also vary depending on the service level of the operator of the mobile terminal 44. By a transmission 25 of the information stored in the code 18 from the mobile terminal 44 to the central server 45, for example via the Internet, this information is also made available to the machine manufacturers. At the central server 45, the information from the code 18 is processed and verified, for example, on the basis of the checksum. By means of a check 26 of the code 18, it is determined whether the transmitted code 18 belongs to the present method 21, i.e. the maintenance or the acknowledgement of maintenance intervals. If the code 18 does not belong to the method 21 for maintenance of the machine 1, a transition 47 is also made here to a corresponding other subroutine. If the code 18 belongs to the method 21, the next step is to check 29 the necessary service level, which is required to reset or acknowledge the maintenance interval. Once the necessary service level of the operator is determined, a checking 30 is performed to determine whether the service level of the operator of the mobile terminal 44 is sufficiently high. If the checking 30 determines that the service level of the operator of the mobile terminal 44 is not sufficient to perform the maintenance on the machine 1, the server 45 transmits this information to the mobile terminal 44, at which an information output 49 occurs informing the operator that his service level is not sufficient to reset the maintenance interval. In this case, a contact to one or more service partners with sufficient service level is indicated to the operator.

In the case where, after checking 30, it is determined that the service level of the operator of the mobile terminal 44 is sufficient to reset the maintenance interval, the next step is to create 34 the release code at the server 45, which is transmitted to the mobile terminal 44 by transmitting 35 the release code. The mobile terminal 44 displays the release code to the operator so that the operator can perform the entry 36 of the release code at the control device 14, for example in the input field 20 on the display device 15. The entry of the release code represents the last step of the maintenance work. The control device 14 checks the release code in accordance with the foregoing. If everything is in order, the release 37 of the maintenance interval takes place, which essentially corresponds to an acknowledgement of the maintenance request or a resetting of the maintenance interval. The method 21 is then completed and ends in step 38.

FIG. 12 shows a flow chart of an alternative method 21 for maintenance of a self-propelled machine 1. The method 21 starts in step 22. Here, too, as in the method 21 according to FIG. 11, the control device 14 first either prompts 60 the operator to perform maintenance due to a time lapse, or the operator initiates this on his or her own. To avoid repetition, reference is made to the above explanations for FIG. 11 for this part of the method 21 according to FIG. 12.

If the operator selects maintenance, either on his or her own initiative or after being prompted 60, an optoelectronically readable code 18 is displayed 23 on the display device 15. Reading 24 of the code 18 by the mobile terminal 44 can then take place, as already described above. In this case, the information stored in the code 18 is read by the mobile terminal 44. The mobile terminal 44 then displays to the operator information about the current operation, for example, about the further process for performing the service. Again, this information may vary depending on the service level of the operator of the mobile terminal 44. For example, the operator is told how to perform the maintenance or who to contact to have the maintenance performed. This is followed by transmitting 25 the information stored in the code 18 from the mobile terminal 44 to the central server 45, for example via the Internet. At the central server 45, the information from the code 18 is processed and verified, for example, using the checksum. Also, a check 26 of the code 18 is performed to determine whether the transmitted code 18 belongs to the present method 21 at all. If the code 18 does not belong to the method 21 for servicing the machine 1, a transition 47 is made to a corresponding other subroutine. If the code 18 belongs to the method 21, the next step is to check 29 the necessary service level, which is required to perform the maintenance on the machine 1 and/or to reset the maintenance interval. Again, this is based on safety aspects to ensure that only sufficiently trained operators perform the respective maintenance on the machine 1. Once the necessary service level of the operator has been determined, a checking 30 is performed to determine whether the service level of the operator of the mobile terminal 44 is sufficiently high. If the checking 30 determines that the service level of the operator of the mobile terminal 44 is not sufficient to perform the maintenance on the machine 1, the server 45 transmits this information to the mobile terminal 44, at which an information output 49 takes place informing the operator that his service level is not sufficient to perform the maintenance and/or to reset the maintenance interval. Again, a contact to a service partner with sufficient service level is indicated to him In the event that, after checking 30, it is determined that the service level of the mobile terminal 44 operator is sufficient to perform the maintenance, the next step is to perform 46 the maintenance itself. This is done, for example, by the operator of the mobile terminal 44, or by a service partner who, however, also has a mobile terminal 44, for example, and who performs the method 21 as part of his service activities. A user with a sufficiently high service level is also shown further, helpful information here, for example instructions for carrying out 46 the maintenance and/or a digital service booklet with a complete machine history, in particular comprising all previous maintenance and/or extension of the range of functions. The warranty status of the machine can also be included in this information.

The further course of the method 21 depends on whether it is possible to detect the completion of the maintenance work by the machine 1, for example by the control device 14. This can succeed, for example, by wear parts being equipped with identification devices, for example RFID chips, and these being read out, or by other sensors being available which detect successful completion of the maintenance. Whether or not the completion of maintenance can be objectively detected in this way may vary from maintenance to maintenance. If such detection is not possible, the operator or service partner performing the maintenance is simply trusted with a sufficient service level. The name of the operator or service partner then stands for the performance and quality of the maintenance. For example, he can confirm that the maintenance has been performed by making an entry on the mobile terminal 44. This is transmitted to the server 45, which then performs the creation 34 of the release code, whereupon a transmission 35 of the release code to the mobile terminal 44 takes place. The mobile terminal 44 displays the release code to the operator so that the operator can perform the entry 36 of the release code at the control device 14, for example in the input field 20 on the display device 15. The entry of the release code represents the last step of the maintenance work. The control device 14 checks the release code in accordance with the foregoing. If everything is in order, the release 37 of the maintenance interval takes place, which essentially corresponds to an acknowledgement of the maintenance request. The method 21 is then completed and ends at step 38.

If, on the other hand, it is possible for the machine 1 to objectively detect, for example via the control device 14 and/or sensors connected to it, that the maintenance work has been carried out, then an additional safety level can be retracted. It is then possible, for example, for a new optoelectronically readable code 18 to be generated by the control device 14 after the maintenance work has been carried out 46, which code contains the detected results of the maintenance. This new code 18 is then made available via a display 23 on the display devices 15, whereupon a new reading 24 of the code 18 by the mobile terminal 44 takes place. The information stored in the new code 18 is then transmitted to the server 45 by a retransmission 25. Based on the transmitted information, a check 26 is then performed at the server 45 to determine whether the maintenance work has been completely and successfully performed. If this is the case, the method 21 continues with the creation 34 of the release code as already described above. If, on the other hand, it is determined that the maintenance has either not been performed completely or not successfully, a corresponding message is generated by the server 45 and transmitted to the mobile terminal 44. An information output 56 is then generated at the mobile terminal 44, informing the operator of the failed maintenance and also indicating to the operator exactly where the problem lies and how to correct it. Alternatively, the operator can again be shown, if necessary, who he can contact to have the problem rectified.

All in all, the method 21 makes it easier, more economical and faster to expand the range of functions or to perform maintenance on a machine 1. This increases the flexibility of the machine 1, since the operator can use all possible machine configurations quickly and easily. At the same time, safe and reliable operation of the machine 1 is ensured by safety mechanisms provided in the process 21.

Finally, the method for mounting a hardware component according to the invention will be illustrated in more detail using an example. For this purpose, reference is made only to FIG. 1 as an example. The hardware component to be attached is a grit spreader 63. This is indicated in dashed lines in FIG. 1 to illustrate that the grit spreader 63 is not initially present. The operator can now call up the additional option “grit spreader” from the operating menu of the machine 1. The control device 14 can now check whether, if applicable, a grit spreader is already present on the machine 1 or whether the requested hardware component is already available. For this purpose, for example, a suitable sensor, in FIG. 1 sensor 64, can be provided which checks, for example mechanically and/or electronically, whether the hardware component is already available at the attachment point for the hardware component. For this purpose, the sensor 64 is in communication with the control device 14 via the signal transmission line 65, and the control device 14 is in communication with the display device 15 via the signal transmission line 66. These can be wired or wireless. The method according to FIG. 10, for example, can now be carried out. If the grit spreader 63 is already attached, the corresponding machine-side control of the grit spreader can now be enabled in the machine operating software via the method shown in FIG. 10, for example. If, on the other hand, the grit spreader 63 is not detected and/or the machine 1 does not permit such a configuration, this can be indicated to the operator after appropriate testing. However, as a supplement or alternative, the sensor 64 can also be, for example, an oil quality sensor or comprise an oil quality sensor which senses the current quality of an oil of the machine 1, for example a hydraulic oil or an engine oil, and transmits the result to the control device 14. This information may also then be transmitted to the central server 45 via the code 18, as explained above.

What is claimed is:

1. A method for the maintenance or extension of the range of functions of a self-propelled machine, in particular a tandem roller, single-drum roller, rubber-wheeled roller, refuse compactor, road finisher, road milling machine, recycler or stabilizer, comprising the steps of:
generating a code, which can be identified at a short distance, by a control device of the machine either automatically by the control device after a maintenance interval has expired or after a request by an operator for an extension of the range of functions, wherein the code contains information about at least one machine state which changes in the course of operation of the machine;
identifying the code by a mobile terminal;
transmitting the information contained in the code to a central server;
transmitting a release code from the server to the mobile terminal;
transmitting the release code to the control device of the machine; and
enabling the maintenance interval or the extension of the range of functions.

2. The method according to claim 1, wherein the code which can be identified at a short distance comprises a signal for wireless transmission of data, in particular an NFC, Bluetooth, WLAN, RFID or infrared signal.

3. The method according to claim 1, wherein the code which can be identified at a short distance is an optoelectronically readable code, and in that the optoelectronically readable code is displayed on a display device of the control device, wherein the identification of the code comprises reading of the optoelectronically readable code by a mobile terminal.

4. The method according to claim 1, wherein transmitting the release code to the control device comprises entering the release code at the control device of the machine by the operator.

5. The method according to claim 1, wherein the code contains at least one of the following pieces of information:
the serial number of the machine;
the location of the machine, for example as GPS coordinates;
a current time at the location of the machine, especially in coordinated universal time (UTC);
the operating time of the machine;
the operating time of a working device of the machine, in particular a drive motor, a vibration drive, a milling drum, a screed heating system and/or a paving screed;
the operating time of a wear part of the machine, in particular an air filter, an oil filter, a scraper, a belt, an ejector, a travel device and/or a wear pad;
an identification of the code;
the type of maintenance whose maintenance interval has expired;
the desired extension of the range of functions;
a current oil quality, for example of a hydraulic oil or an engine oil;
the status of a counter comprised by the control device, which counts, for example, the number of machine starts; and
the current machine configuration, in particular machine hardware and/or machine software.

6. The method according to claim 1, wherein at the central server and/or at the mobile terminal:
a hierarchical structure with at least two service levels is stored, wherein the user of the mobile terminal is assigned a service level, and wherein the mobile terminal displays different information to the user after the code has been identified, depending on the user's service level; and/or
a verification is carried out as to whether the current machine configuration, in particular machine hardware and/or machine software, permits the desired extension of the range of functions; and/or
a verification of the service level of the user of the mobile terminal is carried out, and the further steps, in particular the transmission of the release code from the server to the mobile terminal, are only carried out if the service level of the user is sufficient.

7. The method according to claim 1, wherein an order for an extension of the range of functions is created at the mobile terminal and is transmitted to the central server, wherein the central server performs a transmission of a payment request to the mobile terminal.

8. The method according to claim 1, wherein a verification of a receipt of payment is performed at the central server or at the mobile terminal and the further steps, in particular the transmission of the release code from the server to the mobile terminal, are only performed if a receipt of payment has been detected.

9. The method according to claim 1, wherein the release code is created at the central server or at the mobile terminal, wherein the release code is created in such a way that it is valid only for the relevant machine and/or only for a limited period of time.

10. The method according to claim 1, wherein enabling the extension of the range of functions and/or the release code is valid for an unlimited period of time or for a limited period of time.

11. The method according to claim 1, wherein an information output is displayed to the operator on the mobile terminal in the event of a negative result of a verification, with instructions for solving the problem and/or a contact to a service partner.

12. The method according to claim 1, wherein the operator selects a desired extension of the range of functions from a list of all possible extensions of the range of functions on the control device and/or in that the control device makes suggestions to the operator during operation of the machine regarding available extensions of the range of functions of currently used functions and/or currently enabled extensions of the range of functions of the machine, which can be selected by the operator.

13. The method according to any claim 1, wherein the extension of the range of functions concerns at least one of the following functions:
edge cutter right and/or left;
faster or slower crab steering;
grit spreader;
traffic circle grit spreader;
interface metrology;
obstacle detection;
immobilizer;
radio remote control;
telematics;
seat adjustment;
key assignment of control lever;
activate free-running flow divider;
activate automatic flow divider;
travel lever ramp adjustment;
typing operation;
rotating beacon;
coming/leaving home;
tire pressure control system;
ECO stop;
compaction monitoring;
display modes compaction control;
mirror adjustment;
rear view camera;
bird view;
drone camera;
virtual reality;
asphalt temperature sensor;
machine autonomy or partial autonomy; such as automatic control; automatic following; automatic edge pressing;
automatic leveling;
split scraper blade;
AdBlue filling pump;
dust extraction;
side shield camera; and
activation of the milling drum during reverse travel;
compressed air system.

14. The method according to claim 1, wherein a machine history is created and stored at the central server from the transmitted information contained in the code, and also the enabled maintenance intervals and/or extensions of the range of functions.

15. The method according to claim 1, wherein performing maintenance work on the machine is required before the release code is transmitted.

16. A function or maintenance management system for carrying out the method according to claim 1, comprising a self-propelled machine, in particular a tandem roller, single-drum roller, rubber-wheeled roller, refuse compactor, road finisher, road milling machine, recycler or stabilizer, with a control device and a display device, a mobile terminal and a central server.
